(19) United States
(12) Patent Application Publication
(10) Pub. No.: US 2025/0005547 A1
(43) Pub. Date: Jan. 2, 2025

(54) METHOD FOR ESTABLISHING A REMOTE COMMUNICATION SESSION

(71) Applicant: NCR Voyix Corporation, Atlanta, GA (US)

(72) Inventors: Justin Long, Kennesaw, GA (US); Timothy Fikse, Kennesaw, GA (US); James Colville, Fife (GB); Rafael Torcida, Madrid (ES)

(21) Appl. No.: 18/217,178

(22) Filed: Jun. 30, 2023

(51) Int. Cl. G06Q 20/10

(52) U.S. Cl. CPC G06Q 20/108

(57) ABSTRACT

A data processing system which includes a first device that receives a service request from a first communication session participant. The system initiates a communication session between the first device and a second device. The first device transmits a first image to the second device. The second device creates a second image based on the first image. The second device displays the second image to a second communication session participant. The second device receives user input data from the second communication session participant. The user input data is a selection of pixels on a display screen of the second device. The second device calculates corresponding pixels on a display screen of the first device. The second device creates a control message based on the corresponding pixels and transmits the control message to the first device. The first device performs an action based on the control message to provide a service.

### FIELD OF THE INVENTION

This invention relates to a computer-implemented method for establishing a remote communication session.

### BACKGROUND

It is known for a customer to perform financial transactions using an automated teller machine (ATM), such as withdrawing cash or lodging cheques. However some customers may find it difficult or even impossible to operate certain ATMs.

This invention is aimed at providing an improved method which overcomes at least some of these difficulties.

### SUMMARY

According to the invention there is provided a computer-implemented method for establishing a remote communication session, the method comprising the steps of:
a first device receiving a service request from a first communication session participant,
the first device displaying a first image,
initiating a communication session between the first device and a second device based on the service request,
the first device transmitting the first image to the second device,
the second device determining a second image based on the first image, and
the second device displaying the second image to a second communication session participant.

By displaying the second image at the second device, the method of the invention communicates all of the required information to the second communication session participant. In this manner the second communication session participant may assist the first communication session participant quickly and efficiently.

A teller using the second device may therefore quickly understand where a customer is in the self-service flow. The teller may therefore accurately guide the customer through the process being attempted. This also enables the teller to directly interact with the user flow by selecting or clicking in the display screen of the second device at the teller end which may replicate the display screen of the first device.

The service request may comprise a request for assistance operating the first device. By using the second device, the second communication session participant may assist the first communication session participant to correctly operate the first device. For example a bank teller may assist a customer in performing a financial transaction at an ATM.

The first device may comprise at least one of a teller machine, a cash dispenser device, a printer device, a display device, a user interface device, a document scanner device, an Internet of Things (IoT) enabled device, a media deposit device, a cash recycle device, or a numeric keyboard device.

The first communication session participant may comprise a customer.

The method may comprise the step of determining the second device based on the service request. The second device and the second communication session participant may be selected from a plurality of possible other participants based on availability and/or based on skill to assist the first communication session participant to correctly operate the first device.

The second communication session participant may comprise at least one of a bank teller, an automated machine, a machine learning tool, a computer program, a bank sales agent to assist a customer opening a new bank account or applying for a credit card, or a bank support person to assist a customer with a bank account query or with a credit card query.

The second image may be a visual reproduction of the first image. In this manner the second communication session participant views exactly the same image as the first communication session participant views. This makes it particularly simple and fast for the second communication session participant to guide the first communication session participant how to correctly operate the first device. The second image may be an augmented image based on the first image. The augmented image may better fit the screen size of the second device than the original first image.

The method may comprise the step of the second device receiving user input data from the second communication session participant. The user input data may comprise selection of one or more pixels on a display screen of the second device. The method may comprise the step of the second device determining one or more corresponding pixels on a display screen of the first device. The method may comprise the step of the second device determining a control message based on the one or more corresponding pixels. The method may comprise the step of the second device transmitting the control message to the first device. The method may comprise the step of the first device performing an action based on the control message to provide a required service to the first communication session participant. The selection of pixels at the second device and the subsequent control message is thus equivalent to if the first communication session participant had pressed a finger at the corresponding pixels on the display screen of the first device. In this manner the second communication session participant may take control of operation of the first device. In addition to the selection of the pixels at the second device, a visual effect may be displayed on the display screen of the first device. The visual effect may assist with guidance for the first communication session participant. The first communication session participant may clearly and distinctively see where the second communication session participant clicked on the screen of the second device. Thus the first communication session participant may learn how to perform the required action.

It will be appreciated that instead of a visual effect, an audio effect and/or a haptic effect may be output by the first device to teach the first communication session participant how to perform the required action.

The second device may register one or more clicks on certain pixels of the second screen image. A control messages may be transmitted from the second device to the first device through a series of cloud services. The first device may interpret the control message and perform a programmatic click on the screen on the coordinates instructed by the second device.

The method may comprise the steps of:
the second device determining an assistance message based on the user input data, and
the second device transmitting the assistance message to the first device.

The method may comprise the step of the first device providing output data to the first communication session participant based on the assistance message. The output data may comprise at least one of video data, image data, audio data, text data, or haptic data. The method may comprise the step of the first device receiving user input data from the first communication session participant to control operation of the first device to receive a required service. In this manner the first communication session participant maintains control of operation of the first device. The second communication session participant merely provides instructions, and/or advice, and/or guidance, and/or suggestions to the first communication session participant.

In another aspect of the invention there is provided a data processing system for establishing a remote communication session, the system comprising a first device, a second device, and a processor configured to:
receive a service request from a first communication session participant at the first device,
display a first image at the first device,
initiate a communication session between the first device and the second device based on the service request, transmit the first image from the first device to the second device,
determine a second image based on the first image, and
displaying the second image at the second device to a second communication session participant.

By displaying the second image at the second device, the system of the invention communicates all of the required information to the second communication session participant. In this manner the second communication session participant may assist the first communication session participant quickly and efficiently.

The invention also provides in another aspect a computer program product stored on a non-transitory computer readable storage medium, the computer program product comprising instructions capable of causing a computer system to perform a method of the invention when the computer program product is executed on the computer system.

### BRIEF DESCRIPTION OF THE DRAWING

An embodiment of the invention will be described hereinafter, by way of example only, with reference to the accompanying drawing, in which:

FIG. 1 is a flow diagram of a method according to the invention for establishing a remote communication session.

### DETAILED DESCRIPTION

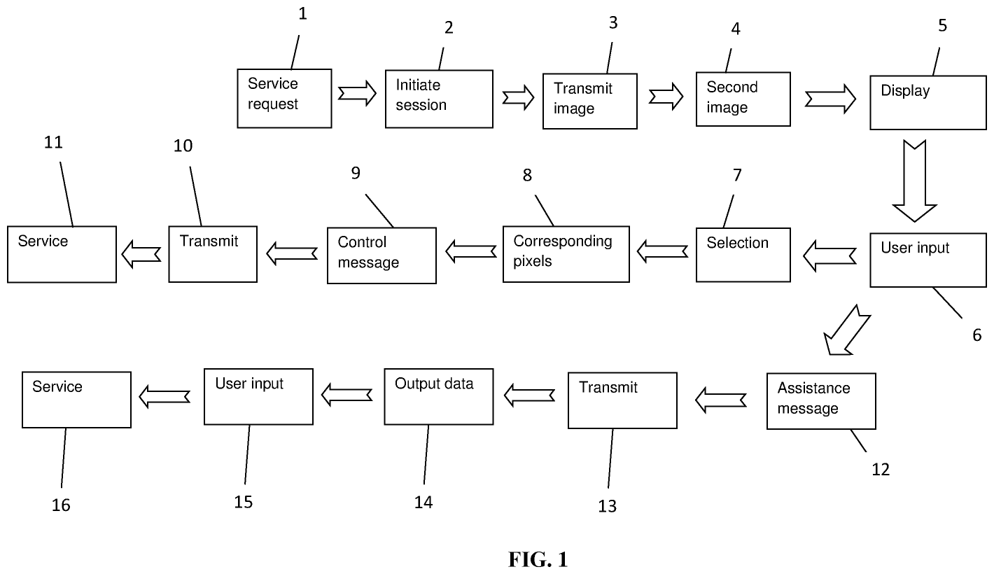

Referring to FIG. 1 there is illustrated a data processing system according to the invention in use. The system may be employed to establish a remote communication session between a first communication session participant and a second communication session participant.

The system comprises a first device. For example the first device may be a teller machine, and/or a cash dispenser device, and/or a printer device, and/or a display device, and/or a user interface device, and/or a document scanner device, and/or an Internet of Things (IoT) enabled device. The first device has a display screen to display a first image, such as a menu of options for the first communication session participant to select. In this case the first communication session participant is a customer.

The system also comprises a second device. For example the second device may be a user interface terminal for use by the second communication session participant. In this case the second communication session participant may be a bank teller, and/or an automated machine, and/or a machine learning tool, and/or a computer program, and/or a financial sales agent, and/or a customer support person, and/or a retail sales agent, and/or a hospitality sales agent.

The first device receives a service request 1 from the first communication session participant. For example the service request 1 may be a request for assistance operating the first device if the customer is finding it difficult to complete a financial transaction at the first device.

Based on the service request 1, the system identifies the second device from a list of possible devices and identifies the second communication session participant from a list of possible participants. The system initiates 2 a communication session between the first device and the second device based on the service request 1. After the communication session has been initiated, the first device transmits various operational data associated with the first device to the second device. In particular the first device transmits 3 the first image to the second device.

The second device creates a second image 4 based on the first image. The second image 4 may be a visual reproduction of the first image. Alternatively the second image 4 may be an augmented image based on the first image. The second device displays 5 the second image 4 to the second communication session participant.

The second device receives user input data 6 from the second communication session participant.

In one example the user input data 6 is a selection 7 of one or more pixels on a display screen of the second device. For example the second communication session participant may provide the user input data 6 to the second device by moving a controller such as a mouse, and/or by selecting pixels on the display screen of the second device by clicking the mouse. The second device calculates one or more corresponding pixels 8 on the display screen of the first device, for example using a pre-defined mathematical correlation function. The second device creates a control message 9 based on the one or more corresponding pixels 8, and the second device transmits 10 the control message 9 to the first device. The first device then performs an action based on the control message 9 to provide a required service 11 to the first communication session participant. In this manner the second communication session participant takes control of the operation of the first device. This control may be from a remotely located desktop application in the second device. The teller may use the remotely located desktop application in the second device to make selections to complete a financial transaction at the first device on behalf of the customer.

In addition to the selection of the pixels at the second device, a visual effect may be displayed on the display screen of the first device. The visual effect may assist with guidance for the first communication session participant. The first communication session participant may clearly and distinctively see where the second communication session participant clicked on the screen of the second device. Thus the first communication session participant may learn how to perform the required action.

It will be appreciated that instead of a visual effect, an audio effect and/or a haptic effect may be output by the first device to teach the first communication session participant how to perform the required action.

In this example the user input data 6 to the second device is not displayed on the display screen of the first device. For example movement of a cursor by the second communication session participant is not visible on the display screen of the first device.

In this example the functionality available for the second communication session participant to perform at the second device, such as navigating the display screen and/or selecting a service option on the display screen, is more limited than the functionality available for the first communication session participant to perform directly at the first device. This enhances the security of the system and enables ease of subsequent auditing of what actions were performed by what participant.

In another example the second device creates an assistance message 12 based on the user input data 6, and the second device transmits 13 the assistance message 12 to the first device. The first device provides output data 14 to the first communication session participant based on the assistance message 12. For example the output data 14 may be video data, and/or image data, and/or audio data, and/or text data, and/or haptic data. The first device then receives user input data 15 from the first communication session participant to control operation of the first device to receive a required service 16. In this manner the first communication session participant maintains control of the operation of the first device. The second communication session participant merely provides instructions, and/or advice, and/or guidance, and/or suggestions to the first communication session participant. The teller may use the remotely located desktop application in the second device to provide prompts to guide the customer through the procedure to allow the customer to complete a financial transaction at the first device.

Throughout the description and claims of this patent specification, the words “comprise” and “contain” and variations of them mean “including but not limited to” and they are not intended to and do not exclude other moieties, additives, components, integers or steps. Throughout the description and claims of this patent specification, the singular encompasses the plural unless the context otherwise requires. In particular, where the indefinite article is used, the patent specification is to be understood as contemplating plurality as well as singularity, unless the context requires otherwise.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

Features, integers, characteristics or groups described in conjunction with a particular aspect, embodiment or example of the invention are to be understood to be applicable to any other aspect, embodiment or example described herein unless incompatible therewith. All of the features disclosed in this patent specification including any accompanying claims, abstract and drawings, and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this patent specification including any accompanying claims, abstract and drawings, or to any novel one, or any novel combination, of the steps of any method or process so disclosed.

What is claimed is:

1. A computer-implemented method for establishing a remote communication session, the method comprising the steps of:
a first device receiving a service request from a first communication session participant,
the first device displaying a first image,
initiating a communication session between the first device and a second device based on the service request,
the first device transmitting the first image to the second device,
the second device determining a second image based on the first image, and
the second device displaying the second image to a second communication session participant.

2. A method as claimed in claim 1 wherein the service request comprises a request for assistance operating the first device.

3. A method as claimed in claim 1 wherein the first device comprises at least one of a teller machine, a cash dispenser device, a printer device, a display device, a user interface device, a document scanner device, or an Internet of Things (IoT) enabled device.

4. A method as claimed in claim 1 wherein the first communication session participant comprises a customer.

5. A method as claimed in claim 1 wherein the method comprises the step of determining the second device based on the service request.

6. A method as claimed in claim 1 wherein the second communication session participant comprises at least one of a bank teller, an automated machine, a machine learning tool, a computer program, a financial sales agent, a customer support person, a retail sales agent, or a hospitality sales agent.

7. A method as claimed in claim 1 wherein the second image is a visual reproduction of the first image.

8. A method as claimed in claim 1 wherein the second image is an augmented image based on the first image.

9. A method as claimed in claim 1 wherein the method comprises the step of the second device receiving user input data from the second communication session participant.

10. A method as claimed in claim 9 wherein the user input data comprises selection of one or more pixels on a display screen of the second device.

11. A method as claimed in claim 10 wherein the method comprises the step of the second device determining one or more corresponding pixels on a display screen of the first device.

12. A method as claimed in claim 11 wherein the method comprises the step of the second device determining a control message based on the one or more corresponding pixels.

13. A method as claimed in claim 12 wherein the method comprises the step of the second device transmitting the control message to the first device.

14. A method as claimed in claim 13 wherein the method comprises the step of the first device performing an action based on the control message to provide a required service to the first communication session participant.

15. A method as claimed in claim 9 wherein the method comprises the steps of:
the second device determining an assistance message based on the user input data, and
the second device transmitting the assistance message to the first device.

16. A method as claimed in claim 15 wherein the method comprises the step of the first device providing output data to the first communication session participant based on the assistance message.

17. A method as claimed in claim 16 wherein the output data comprises at least one of video data, image data, audio data, text data, or haptic data.

18. A method as claimed in claim 16 wherein the method comprises the step of the first device receiving user input data from the first communication session participant to control operation of the first device to receive a required service.

19. A data processing system for establishing a remote communication session, the system comprising a first device, a second device, and a processor configured to:
receive a service request from a first communication session participant at the first device,
display a first image at the first device,
initiate a communication session between the first device and the second device based on the service request,
transmit the first image from the first device to the second device,
determine a second image based on the first image, and
displaying the second image at the second device to a second communication session participant.

20. A computer program product stored on a non-transitory computer readable storage medium, the computer program product comprising instructions capable of causing a computer system to perform a method as claimed in claim 1 when the computer program product is executed on the computer system.
